(19) United States
(12) Patent Application Publication
(10) Pub. No.: US 2018/0056508 A1
(43) Pub. Date: Mar. 1, 2018

(54) MOTOR UNIT AND ROBOT

(71) Applicant: Seiko Epson Corporation, Tokyo (JP)

(72) Inventor: Seiji HAHAKURA, Azumino (JP)

(21) Appl. No.: 15/691,039

(22) Filed: Aug. 30, 2017

(30) Foreign Application Priority Data
Aug. 31, 2016 (JP) 2016-168985
May 31, 2017 (JP) 2017-107558

(51) Int. Cl. B25J 9/04; B25J 9/12; H02K 11/33

(52) U.S. Cl. CPC B25J 9/043; H02K 11/21; H02K 11/33; B25J 9/126

(57) ABSTRACT

A motor unit includes a first motor and a first amplifier section including a driving circuit for driving the first motor. The first motor includes a first section configured to enable the first amplifier section to be attached to and detached from a first position and a second section configured to enable the first amplifier section to be attached to and detached from a second position different from the first position.

### BACKGROUND

### 1. Technical Field

The present invention relates to a motor unit and a robot.

### 2. Related Art

A multi-joint robot including a plurality of arms is used in the industrial field and the like. It is known that, in the multi-joint robot, driving circuits for driving motors are provided together with the motors on the insides of the arms (see, U.S. Pat. No. 7,347,120 (Patent Literature 1)).

When a driving circuit (an amplifier section) is provided on the inside of an arm, the size of the arm increases. As a result, a movable range of the arm decreases.

Therefore, there is a demand for a motor unit with improved universality that can be disposed in various spaces in a variety of directions by improving flexibility of disposition of the motor and the amplifier section. There is also a demand for a robot in which the arm is formed compact by effectively making use of a space in the arm using such a motor unit.

### SUMMARY

A motor unit according to an aspect of the invention includes: a first motor; and a first amplifier section including a driving circuit for driving the first motor. The first motor includes: a first section configured to enable the first amplifier section to be attached to and detached from a first position; and a second section configured to enable the first amplifier section to be attached to and detached from a second position different from the first position.

According to this configuration, it is possible to attach the first amplifier section to a plurality of positions with respect to the first motor. Consequently, it is possible to improve flexibility of disposition of the first motor and the first amplifier section on the inside of an arm. As a result, it is possible to form the arm compact.

In the motor unit according to the aspect, the first position and the second position may be located on different surfaces on a surface of the first motor.

According to this configuration, it is possible to dispose the first amplifier section according to a gap on the inside of the arm by disposing the first amplifier section on the difference surfaces of the first motor.

In the motor unit according to the aspect, a rotating shaft of the first motor may be provided between the first position and the second position.

According to this configuration, when a pair of amplifier sections is fixed to the first motor, it is possible to array the pair of amplifier sections and the motor in one direction. Consequently, it is possible to effectively use a space on the inside of the arm by disposing the pair of amplifier sections and the first motor in the longitudinal direction of the arm.

In the motor unit according to the aspect, the second section may be capable of attaching and detaching a second amplifier section including a driving circuit for driving a second motor different from the first motor.

According to this configuration, it is possible to fix two amplifier sections to one motor. Consequently, it is possible to improve flexibility of disposition of the motors and the amplifier sections on the inside of the arm. As a result, it is possible to form the arm compact.

A motor unit according to another aspect of the invention includes: a first motor; and a first amplifier section including a driving circuit for driving the first motor. The first motor includes a first section configured to enable the first amplifier section to be attached and detached. The first amplifier section includes a third section configured to enable a second amplifier section, which includes a driving circuit for driving a second motor different from the first motor, to be attached and detached.

According to this configuration, it is possible to fix a plurality of amplifier sections to one motor to be stacked one on top of another. Consequently, it is possible to improve flexibility of disposition of the motors and the amplifier sections on the inside of an arm. As a result, it is possible to form the arm compact.

In the motor unit according to the aspect, interposed members may be interposed between the sections and the amplifier sections.

According to this configuration, it is possible to adjust, with the interposed members, the positions and the postures of the amplifier sections with respect to the motors. It is possible to improve flexibility of disposition of the motors and the amplifier sections on the inside of the arm. As a result, it is possible to form the arm compact.

A robot according to still another aspect of the invention includes: the motor unit; an arm capable of rotating around a rotation axis; and an actuating shaft body provided in the arm and configured to rotate around an actuation axis. Either one of the first motor and the second motor drives the arm around the rotation axis. The other drives the actuating shaft body.

According to this configuration, since the two amplifier sections are fixed to the one motor, it is possible to improve flexibility of disposition of the motors and the amplifier sections on the inside of the arm. As a result, it is possible to provide the robot in which the arm is formed compact.

### BRIEF DESCRIPTION OF THE DRAWINGS

The invention will be described with reference to the accompanying drawings, wherein like numbers reference like elements.

FIG. 1 is a perspective view showing a robot according to a first embodiment.

FIG. 2 is an exploded perspective view of a second arm in the first embodiment.

FIG. 3 is a sectional view around a section axis of the second arm in the first embodiment.

FIG. 4 is a plan view of the second arm in the first embodiment.

FIG. 5 is a side view of a first motor unit according to the first embodiment.

FIG. 6 is a partial perspective view of an arm main body in the first embodiment.

FIG. 7 is a plan view of a second arm in the modification 1.

FIG. 8 is a side view of a second motor unit in the modification 1.

FIG. 9 is a side view of a motor unit in a modification 2.

FIG. 10 is a side view of a motor unit in a modification 3.

FIG. 11 is a plan view of a second arm in a second embodiment.

FIG. 12 is a schematic plan view of the second arm in a third embodiment.

### DESCRIPTION OF EXEMPLARY EMBODIMENTS

### First Embodiment

A first embodiment is explained below with reference to the drawings.

In the drawings used in the following explanation, to clearly show characteristics, characteristic portions are sometimes enlarged and shown for convenience. The dimension ratios and the like of components are not always the same as actual dimension ratios and the like. An X-Y-Z coordinate system is shown in the figures. In the following explanation, directions are explained on the basis of coordinate systems according to necessity. Note that, in this specification, sections are explained assuming that a +Z direction is an upward direction. However, the posture of a robot is not limited to a posture that the robot takes when the +Z direction is the upward direction.

Note that, in this specification, “extend along a certain direction (a designated direction)” includes, in addition to extending along the designated direction in a strict sense, extending along a direction tilting in a range of less than 45° with respect to the designated direction. On the other hand, in this specification, “in a certain direction (a designated direction)” is used when designating a direction in a strict sense.

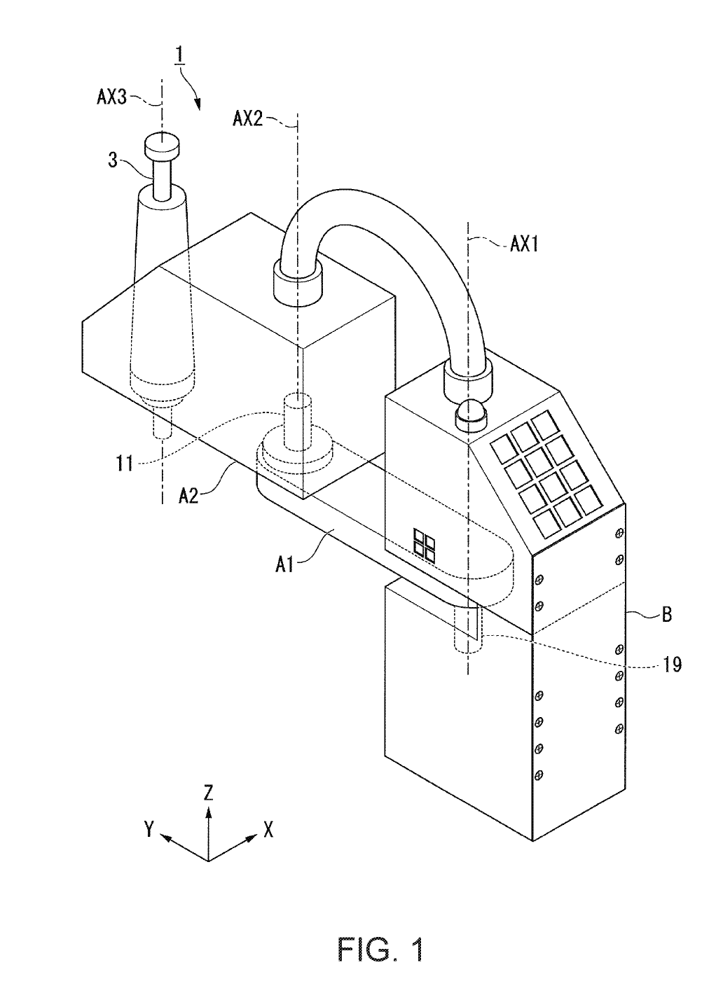

FIG. 1 is a schematic perspective view of a robot 1 according to this embodiment.

The robot 1 according to this embodiment is a SCARA robot. The robot 1 includes a supporting stand B, a first arm A1, a second arm A2, and an actuating shaft body 3.

The supporting stand B is set on a setting surface such as a floor surface or a wall surface. The first arm A1 is supported by the supporting stand B. The first arm A1 is rotated around a first axis AX1 by a motor unit 19 provided on the inside of the supporting stand B. The second arm A2 is supported to be capable of rotating around a second axis AX2 by the first arm A1. The actuating shaft body 3 is supported by the second arm A2. The actuating shaft body 3 is capable of rotating around a third axis AX3 and capable of translating in the axial direction of the third axis AX3.

In this embodiment, the supporting stand B of the robot 1 is fixed to a floor surface parallel to an X-Y plane. All of the first axis AX1, the second axis AX2, and the third axis AX3 are parallel to the up-down direction (a Z-axis direction). The first arm A1 and the second arm A2 of the robot 1 operate in parallel to an XY plane. In this specification, a state viewed from the axial direction of the second axis AX2 is referred to as plan view.

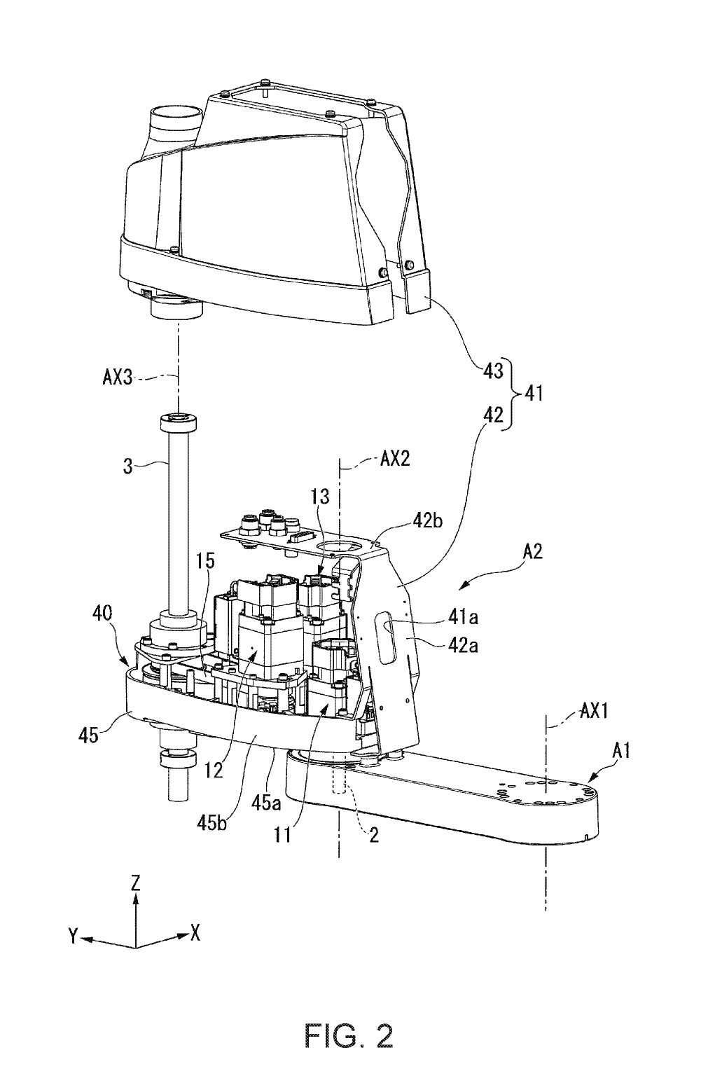

FIG. 2 is an exploded perspective view of the second arm A2.

The second arm A2 includes an arm main body 40, an arm cover 41, a first motor unit 11, a second motor unit 12, a third motor unit 13, a rotation shaft body 2 extending along the second axis (a rotation axis) AX2, and an actuating shaft body 3 extending along the third axis (an actuation axis) AX3.

The arm main body 40 holds the arm cover 41, the first to third motor units 11, 12, and 13, the actuating shaft body 3, and the rotation shaft body 2. The arm main body 40 includes a lower cover 45. The lower cover 45 includes a bottom plate section 45a to which the first to third motor units 11, 12, and 13 are fixed from the upward direction and a sidewall section 45b projecting to the upper side from the outer edge of the bottom plate section 45a. The lower cover 45 covers the lower side of the second arm A2.

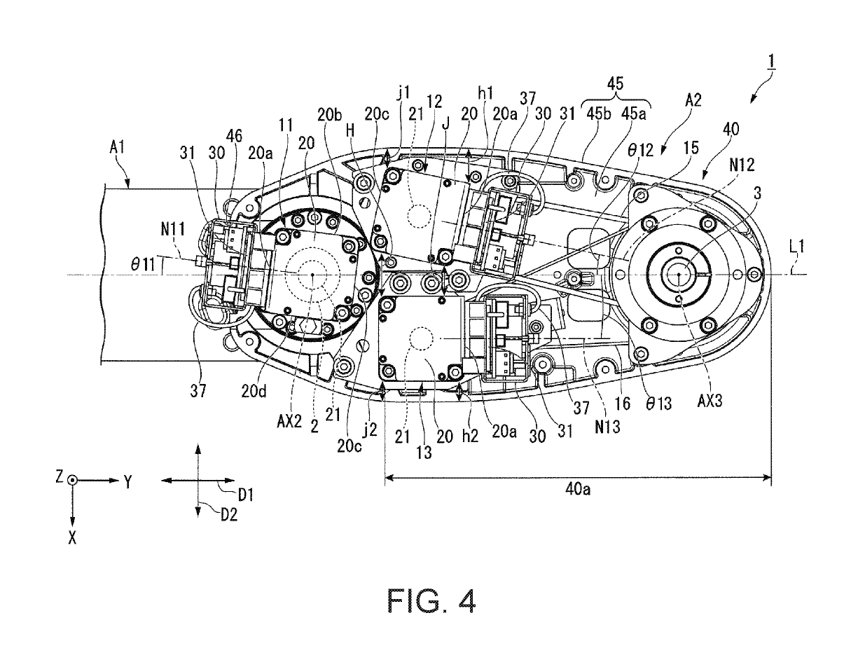

The arm cover 41 covers the first to third motor units 11, 12, and 13 (i.e., a plurality of motors 20 and a plurality of amplifier sections 30 (see FIG. 4)) in plan view. The arm cover 41 includes a frame body 42 and a cover main body 43. The frame body 42 is formed by sheet metal working. The frame body 42 includes an erected section 42a erected upward in a side portion of the rotation shaft body 2 and an upper end portion 42b extending in the horizontal direction from the upper end of the erected section 42a. The frame body 42 is fixed to the lower cover 45 at the lower end of the erected section 42a. The cover main body 43 is fixed to the frame body 42 and the lower cover 45.

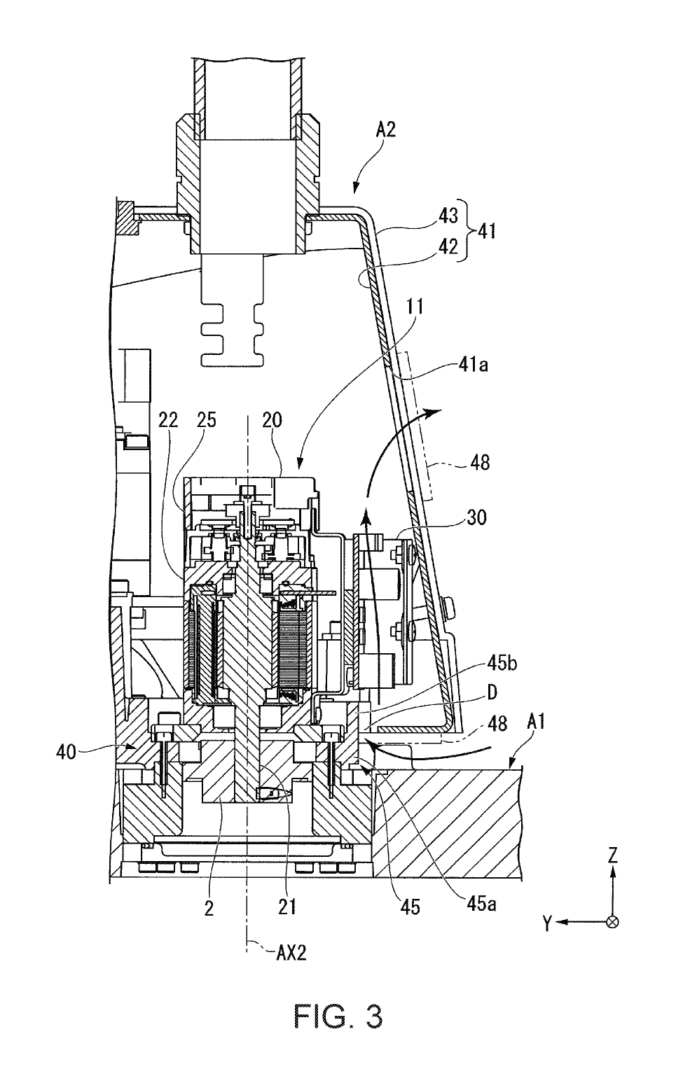

FIG. 3 is a sectional view around the second axis AX2 of the second arm A2.

A gap D extending in the horizontal direction is provided between the arm cover 41 and the lower cover 45. That is, an inner space of the second arm A2 surrounded by the arm cover 41 and the lower cover 45 is opened to the outside in the up-down direction in the gap D. The gap D is located immediately below the amplifier section 30 of the first motor unit 11.

In the arm cover 41, a vent hole 41a is provided immediately above the simplifier section 30 of the first motor unit 11. The vent hole 41a causes the inner space of the second arm A2 surrounded by the arm cover 41 and the lower cover 45 to communicate with the outside.

FIG. 4 is a plan view of the second arm A2. In FIG. 4, the arm cover 41 is detached.

The first motor unit 11 is fixed to the arm main body 40. The first motor unit 11 drives to rotate the rotation shaft body 2 with respect to the arm main body 40. Since the rotation shaft body 2 is fixed to the first arm A1, when the rotation shaft body 2 is driven to rotate, the second arm A2 rotates around the second axis AX2 with respect to the first arm A1.

The second motor unit 12 moves (lifts and lowers) the actuation shaft body 3 in the up-down direction. A ball screw groove (not shown in the figure) is provided in the actuating shaft body 3. The actuating shaft body 3 is supported by the arm main body 40 via a ball screw nut (not shown in the figure) fit in the ball screw groove. The second motor unit 12 rotates the ball screw nut via a timing belt 15 to lift and lower the actuating shaft body 3.

The third motor unit 13 rotates the actuating shaft body 3 around the third axis AX3 via a timing belt 16. That is, the actuating shat body 3 is moved in the up-down direction by the second motor unit 12 and rotated around an axis by the third motor unit 13.

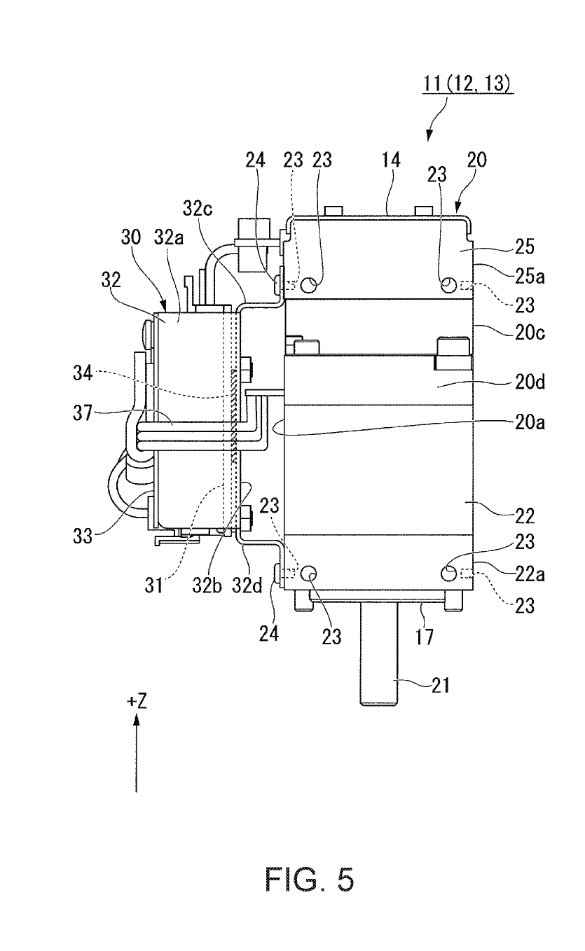

FIG. 5 is a side view of the first motor unit 11.

In this embodiment, the first to third motor units 11, 12, and 13 have the same configuration. Components explained below concerning the first motor unit 11 are the same in the second and third motor units 12 and 13 except when particularly designated.

The first motor unit 11 includes the motor 20 and the amplifier section 30 including an amplifier board 31 on which a driving circuit for driving the motor 20 is mounted.

The motor 20 is disposed with the axial direction of a shaft 21 aligned in the Z-axis direction. The motor 20 has a rectangular shape when viewed from the axial direction of the shaft 21. The motor 20 has a substantially rectangular parallelepiped shape. The motor 20 includes the shaft 21, a motor main body 22, and an encoder 25.

The amplifier section 30 is provided in (attached to) the motor 20. The amplifier section 30 is detachably attachable to the motor 20. A cable 37 projecting in a sideward direction is provided in the amplifier section 30. Any one of the plurality of amplifier sections 30 may be directly provided in the arm main body 40 or may be fixed to each of the motor 20 and the arm main body 40.

The motor main body 22 and the encoder 25 are stacked and fixed in the axial direction of the shaft 21. The motor main body 22 rotates the shaft 21. The motor main body 22 in this embodiment is a three-phase AC motor. Note that the motor main body 22 may be another motor. The motor main body 22 includes a motor housing 22a that surrounds an internal structure from the radial direction outer side of the shaft 21.

The encoder 25 detects a rotation angle of the shaft 21. The encoder 25 may be a magnetic encoder, may be an optical encoder, or may be a combination of the magnetic encoder and the optical encoder. The encoder 25 includes an encoder housing 25a that surrounds an internal structure from the radial direction outer side of the shaft 21.

The motor 20 has a vertically long substantially parallelepiped shape extending along the axial direction of the shaft 21. The outer peripheral surface of the motor 20 includes first to fourth surfaces 20a, 20b, 20c, and 20d (for the second surface 20b, see FIG. 4) surrounding the periphery of the shaft 21 and a bottom surface 17 and a top surface 14 orthogonal to the axial direction of the shaft 21. The shaft 21 projects downward from the bottom surface 17.

As shown in FIG. 4, both of the first surfaces 20a of the second and third motor units 12 and 13 face the third axis AX3 side (i.e., a +Y direction). The first surface 20a of the first motor unit 11 faces the opposite side of the first surfaces 20a of the second and third motor units 12 and 13.

As shown in FIG. 5, four screw holes (attaching/detaching sections) 23 are provided in each of the first to fourth surfaces 20a, 20b, 20c, and 20d of the motor 20. Two screw holes 23 of the four screw holes 23 are provided in the encoder housing 25a. The remaining two screw holes 23 are provided in the motor housing 22a. The four screw holes provided in each of the surfaces function as attaching/detaching sections for fixing the amplifier section 30 to the surface. In all of the first to third motor units 11, 12, and 13 according to this embodiment, the amplifier section 30 is fixed to the first surface 20a. Therefore, the amplifier section 30 is fixed by inserting screws (fixing members) 24 respectively into the four screw holes 23 provided in the first surface 20a. In this embodiment, the screw holes 23 respectively provided in the second to fourth surfaces 20b, 20c, and 20d are not used.

In the motor (a first motor) 20 of the first motor unit 11 according to this embodiment, four screw holes (first sections) 23 that enable the amplifier section (a first amplifier section) 30 for driving the motor 20 to be attached and detached are provided in the first surface (a first position) 20a. In the motor (the first motor) 20 of the first motor unit 11, four screw holes (each of second to fourth sections) 23 that enable the amplifier section (a first amplifier section) 30 to be attached and detached are provided in each of the second to fourth surfaces (second to fourth positions) 20b, 20c, and 20d. According to this embodiment, it is possible to attach the amplifier section 30 to various positions of the motor 20. Therefore, it is possible to change an attaching position of the amplifier section 30 according to a setting space. It is possible to achieve common use of components of the motor units.

In the motor 20 according to this embodiment, the first to fourth positions (i.e., the first to fourth surfaces 20a, 20b, 20c, and 20d) to which the amplifier section 30 can be attached are located on different surfaces of the surface of the motor 20. Therefore, by changing the attaching position of the amplifier section 30, it is possible to change a direction of the amplifier section 30 with respect to the motor 20.

Note that the first to fourth positions to which the amplifier section 30 can be attached maybe the same surface on the surface of the motor 20 and may be at different heights.

Further, in this embodiment, since the first to third motor units 11, 12, and 13 include the same amplifier sections 30. Therefore, the amplifier sections 30 of the other motor units may be attached to the motor 20 of the first motor unit 11.

The amplifier section 30 includes an amplifier board 31, a bracket 32, and an amplifier cover 33. The amplifier section 30 is fixed to the first surface 20a of the motor 20 via the bracket 32. Cables for power supply and for control drawn around from the supporting stand B are connected to the amplifier section 30. A cable connected to the motor 20 to supply electric power to the motor 20 and control the motor 20 is connected to the amplifier section 30.

The amplifier board 31 amplifies electric power supplied from a power supply and supplies the electric power to the motor main body 22. More specifically, when operating the motor main body 22, the amplifier board 31 supplies electric power to coils (not shown in the figure) of respective three phases included in the motor 20 at timing corresponding to the control signal. The bracket 32 is formed of a material having high thermal conductivity and is formed of, for example, aluminum.

The bracket 32 includes a pair of side plate sections 32a, a back surface plate section 32b, a first leg plate section 32c, and a second leg plate section 32d. The bracket 32 is formed by sheet metal working.

The pair of side plate sections 32a faces each other across the amplifier board 31. A surface direction of the pair of side plate sections 32a is orthogonal to a surface direction of the amplifier board 31. The pair of side plate sections 32a extends in the vertical direction.

The back surface plate section 32b of the bracket 32 joins the pair of side plate sections 32a. The back surface plate section 32b is located between the amplifier board 31 and the first surface 20a of the motor 20. The back surface plate section 32b is disposed along the amplifier board 31. Therefore, a surface direction of the back surface plate section 32b coincides with a surface direction of the amplifier board 31. The back surface plate section 32b is in contact with the amplifier board 31 via a heat transfer sheet 34. On the other hand, a gap is provided between the back surface plate section 32b and the first surface 20a of the motor 20.

The first leg plate section 32c of the bracket 32 extends from the upper end of the back surface plate section 32b toward the motor 20. The second leg plate section 32d extends from the lower end of the back surface plate section 32b toward the motor 20. The distal end portions of the first leg plate section 32c and the second leg plate section 32d are bent to be parallel to the first surface 20a of the motor 20. Holes through which screws are inserted are provided in the distal end portions. The bracket 32 is fixed to the motor 20 by inserting the screws 24, which are inserted through the first and second leg plate sections 32c and 32d, into the screw holes 23 in the first surface 20a of the motor 20. In this embodiment, the first and second leg plate sections 32c and 32d are parts of the bracket 32. However, the first and second leg plate sections 32c and 32d may be separate from the bracket 32. In that case, the first and second leg plate sections 32c and 32d function as interposed members interposed between the amplifier section 30 and the screw holes (the attaching/detaching sections) 23.

The heat transfer sheet 34 is interposed between the back surface plate section 32b of the bracket 32 and the amplifier board 31. The heat transfer sheet 34 is in surface contact with the back surface plate section 32b and the amplifier board 31. The heat transfer sheet 34 transfers heat generated in the amplifier board 31 to the bracket 32. Since the bracket 32 has a large exposed surface area, the bracket 32 is excellent in heat radiation efficiency. The bracket 32 functions as a heat sink for radiating heat from the amplifier board 31.

### Disposition of the Motors

Disposition of the first to third motor units 11, 12, and 13 provided in the arm main body 40 is explained. As shown in FIG. 4, a straight line connecting the second axis AX2 and the third axis AX3 when viewed from the axial direction of the second axis AX2 (the Z-axis direction) is represented as a first straight line L1. A direction parallel to the first straight line L1 (a Y-axis direction in FIG. 4) is represented as a first direction D1. A direction orthogonal to the first direction D1 is represented as a second direction D2. The arm main body 40 is formed vertically long in one direction (the first direction D1) with the first direction D1 set as a longitudinal direction and the second direction D2 set as a latitudinal direction in plan view.

The first motor unit 11 directly drives the rotation shaft body 2. The shaft 21 of the first motor unit 11 is connected to the rotation shaft body 2 in a state in which the centers of the shaft 21 and the rotation shaft body 2 are aligned. Therefore, the first motor unit 11 is located on the second axis AX2 of the rotation shaft body 2. The first motor unit 11 is located on the first straight line L1.

The second and third motor units 12 and 13 are disposed side by side along the second direction. In plan view, the second motor unit 12 is located on one side of two regions on the inside of the arm main body 40 sectioned by the first straight line L1. The third motor unit 13 is located on the other side.

The second and third motor units 12 and 13 are heaviest components among components mounted on the arm main body 40. In the second arm A2 that rotates around the second axis AX2, when heavy components are disposed away from the second axis AX2, an inertial moment (inertia) increases. When the inertial moment increases, precise control of the second arm A2 is difficult. By disposing the second and third motor units 12 and 13 side by side along the second direction D2, it is possible to dispose the second and third motor units 12 and 13 close to the second axis AX2 compare with when the second and third motor units 12 and 13 are disposed side by side in the first direction D1. Consequently, it is possible to reduce the inertial moment of the second arm A2.

In an illustration in this embodiment, two motor units (the second and third motor units 12 and 13) among the three motor units 11, 12, and 13 are disposed side by side along the second direction D2. However, all of the motor units 11, 12, and 13 may be disposed side by side along the second direction D2.

The disposition of the motor units 11, 12, and 13 is explained above. Most of the weight of the motor units 11, 12, and 13 is the weight of the motors 20. Therefore, the motor 20 only has to be disposed as explained above irrespective of the disposition of the amplifier section 30. That is, at least two motors 20 among the plurality of motors 20 only have to be disposed side by side along the second direction D2.

In each of the first to third motor units 11, 12, and 13, the motor 20 and the amplifier section 30 are disposed along the first direction D1. That is, in each of the first to third motor units 11, 12, and 13, the direction of the amplifier section 30 with respect to the motor 20 is along the first direction D1. Note that the direction of the amplifier section 30 with respect to the motor 20 is the direction of the straight light connecting the center of the motor 20 (the center axis of the shaft 21) and the center of a projection area of the amplifier section 30 viewed from the center of the motor 20. When it is attempted to secure a space in the second direction D2, which coincides with the latitudinal direction, the second arm A2 increases in size in the second direction D2 (i.e., the width direction). When the second arm A2 increases in size in the width direction, a movable range of the second arm A2 decreases. On the other hand, since the first direction D1 is the longitudinal direction of the second arm A2, it is easy to secure a housing space of the second arm A2 along the first direction D1. By disposing the motor 20 and the amplifier section 30 along the first direction D1, it is possible to effectively utilize the space in the longitudinal direction of the second arm A2 and prevent the second arm A2 from increasing in size in the second direction D2.

Note that, in the illustration in this embodiment, in each of the first to third motor units 11, 12, and 13, the amplifier section 30 is disposed along the first direction D1 with respect to the motor 20. However, if the amplifier section is disposed in a direction different from the second direction D2 with respect to the motor 20, it is possible to achieve the effects explained above according to an angle of the amplifier section 30. Specifically, the amplifier section 30 may be disposed in the center axis direction of the shaft 21 (the Z-axis direction) with respect to the motor 20.

In each of the first to third motor units 11, 12, and 13, the motor 20 is disposed in a position closer to the second axis AX2 than the amplifier section 30. More specifically, the center of gravity of the motor 20 is closer to the second axis AX2 than the center of gravity of the amplifier section 30 in plan view. In each of the first to third motor units 11, 12, and 13, in general, the motor 20 is heavier than the amplifier section 30. The center of gravity of each of the first to third motor units 11, 12, and 13 including the motor 20 and the amplifier section 30 is located on the motor 20 side. By disposing the motor 20 on the second axis AX2 side with respect to the amplifier section 30, it is possible to bring the center of gravity of each of the first to third motor units 11, 12, and 13 closer to the second axis AX2 and reduce the inertial moment.

As shown in FIG. 4, in plan view, the amplifier boards 31 of the first to third motor units 11, 12, and 13 face predetermined normal directions N11, N12, and N13. In this embodiment, the normals of the amplifier boards 31 passing the centers of the amplifier sections 30 pass the centers of the motors 20. Therefore, the normal directions N11, N12, and N13 of the amplifier boards 31 and the directions of the amplifier sections 30 with respect to the motors 20 coincide with each other. In the following explanation, it is assumed that the normal directions N11, N12, and N13 of the amplifier sections 30 are synonymous with the directions of the amplifier section 30 with respect to the motor 20.

The normal direction N11 of the amplifier board 31 of the first motor unit 11 is nonparallel to the first direction D1. Consequently, it is possible to dispose the amplifier section 30 including the cable 37 in the center of a first opening section 46 provided in the lower cover 45 explained below.

The cable 37 of the second motor unit 12 is disposed on the outer side with respect to the first straight line L1. Therefore, it is necessary to prevent the cable 37 from being held between the arm cover 41 (see FIG. 2) and the lower cover 45. Therefore, it is desirable to set the overall dimension of the second motor unit 12 including the cable 37 as the dimension of the second motor unit 12. In the second motor unit 12, the width of the amplifier section 30 including the cable 37 is larger than the width of the motor 20. The width means a direction in a direction orthogonal to the normal direction N12 of the amplifier board 31. In this embodiment, the second motor unit 12 is disposed to be tilted to direct the amplifier section 30 to the first straight line side. That is, the normal direction N12 of the amplifier board 31 of the second motor unit 12 is nonparallel to the first direction D1. By setting the normal direction N12 nonparallel to the first direction D1, compared with when the normal direction N12 is parallel to the first direction D1, it is easy to reduce the dimension along the second direction D2 in the entire second motor unit 12 including the cable 37. As a result, it is possible to reduce the width dimension (the dimension along the second direction D2) of the second arm A2.

The normal direction N13 of the amplifier board 31 of the third motor unit 13 is parallel to the first direction D1. Consequently, the dimension along the second direction D2 of the third motor unit 13 decreases. That is, a space along the second direction D2 for housing the third motor unit 13 in the second arm A2 decreases. As a result, it is possible to reduce the dimension along the second direction D2 of the second arm A2.

In this embodiment, the second motor unit 12 and the third motor unit 13 are disposed side by side along the second direction D2. That is, the two motors 20 among the plurality of motors 20 provided in the second arm A2 are disposed side by side along the second direction D2.

In plan view, a shortest distance j1 in the second direction D2 between the motor 20 of the second motor unit 12 and the outer edge of the arm main body 40 is smaller than the thickness of the amplifier section 30. Similarly, a shortest distance j2 in the second direction D2 between the motor 20 of the third motor unit 13 and the outer edge of the arm main body 40 is smaller than the thickness of the amplifier section 30. Consequently, it is possible to reduce the distance between the motor 20 and the outer edge of the arm main body 40 and reduce the dimension along the second direction D2 of the arm main body 40. Further, a shortest distance J in the second direction D2 between the motors 20 of the second and third motor units 12 and 13 is smaller than the thickness of the amplifier section 30. Consequently, it is possible to reduce the distance between the motors 20 of the second and third motor units 12 and 13 and reduce the dimension along the second direction D2 of the arm main body 40.

Note that the thickness of the amplifier section 30 is the length of the short side of the two sides of the amplifier section 30 having a substantially rectangular shape in plan view. In this embodiment, the thickness of the amplifier section 30 means the length of the amplifier section 30 in the normal directions N12 and N13 of the amplifier board 31. In the second direction D2, the outer edge of the arm main body 40 substantially coincides with the outer edge of the second arm A2.

In plan view, a longest distance h1 along the second direction D2 between the motor 20 (the first motor) of the second motor unit 12 and the outer edge of the arm main body 40 on the opposite side of the motor 20 (the second motor) of the third motor unit 13 with respect to the motor 20 of the second motor unit 12 is smaller than the thickness of the amplifier section 30. Similarly, a longest distance h2 along the second direction D2 between the motor 20 (the second motor) of the third motor unit 13 and the outer edge of the arm main body 40 on the opposite side of the motor 20 (the first motor) of the second motor unit 12 with respect to the motor 20 of the third motor unit 13 is smaller than the thickness of the amplifier section 30. That is, the longest distances h1 and h2 in the second direction D2 between the motors 20 located at both ends in the second direction D2 among the plurality of motors (the motors 20 of the second and third motor units 12 and 13) and the outer edge of the arm main body 40 located on the outer side of the motors 20 are smaller than the thickness of the amplifier section 30. Further, a longest distance H along the second direction D2 between the motors 20 of the second and third motor units 12 and 13 is smaller than the thickness of the amplifier section 30. A gap in which the amplifier section 30 is provided is absent between the outer edge of the arm main body 40 and the motors 20 of the second and third motor units 12 and 13 and between the motors 20 of the second and third motor units 12 and 13. As a result, it is possible to reduce the dimension along the second direction D2 of the second arm A2. The amplifier section 30 is disposed in the first direction D1 with respect to the motor 20.

Note that, in this embodiment, the outer shape of the motor 20 of the third motor unit 13 and the outer edge of the arm main body 40 located on the side of the motor 20 are parallel. Therefore, the shortest distance j2 and the longest distance h2 are the same between the third motor unit 13 and the outer edge of the arm main body 40.

In the first to third motor units 11, 12, and 13, angles θ11, θ12, and θ13 formed by the normal directions N11, N12, and N13 of the amplifier boards 31 and the first direction D1 is desirably set to 0° or more and 45° or less and more desirably set to 5° or more and 20° or less. Note that, since the normal direction N13 of the amplifier board 31 of the third motor unit 13 is parallel to the first direction D1, the angle θ13 is 0°. Concerning the second and third motor units 12 and 13, a positive angel in the angle range explained above is an angle in a direction closer to the first straight line L1 further away from the second axis AX2. On the other hand, concerning the first motor unit 11, since the second axis AX2 and the center axis of the shaft 21 of the motor 20 coincide with each other, the angel in the angle range may be either positive or negative.

By setting the angles θ11, θ12, and θ13 to 0° or more and 45° or less and more desirably to 5° or more and 20° or less, it is possible to reduce the dimension of the second arm A2 along the second direction D2. By setting the angles θ11 and θ12 to 5° or more, it is possible to reduce the dimension along the second direction D2 of the first and second motor units 11 and 12 including the cable 37. Further, when the angle θ12 of the second motor unit 12 is set to 5° or more, the normal direction N11 and N12 tilt in the direction closer to the first straight line L1 further away from the second axis AX2. Consequently, as shown in FIG. 4, in the outer shape of the arm main body 40 in plan view, a wedge shape section 40a, the width along the second direction D2 of which decreases from the second axis AX2 toward the third axis AX3, is formed along the first straight line L1. The wedge shape section 40a is provided in a region from the second and third motor units 12 and 13 to the distal end on the third axis AX3 side in the longitudinal direction of the arm main body 40. Since the wedge shape section 40a is provided, it is possible to reduce a projection area of the arm main body 40 in plan view. As a result, it is possible to expand a movable area of the second arm A2. Note that, according to this embodiment, whereas the angle θ12 of the second motor unit 12 is set to 5° or more, the angle θ13 of the third motor unit 13 is 0°. In this way, when the plurality of motor units are disposed side by side in the second direction, by setting the angle of one of the motor units to 5° or more, it is possible to expect an effect of further reducing the projection area of the arm main body 40 in plan view.

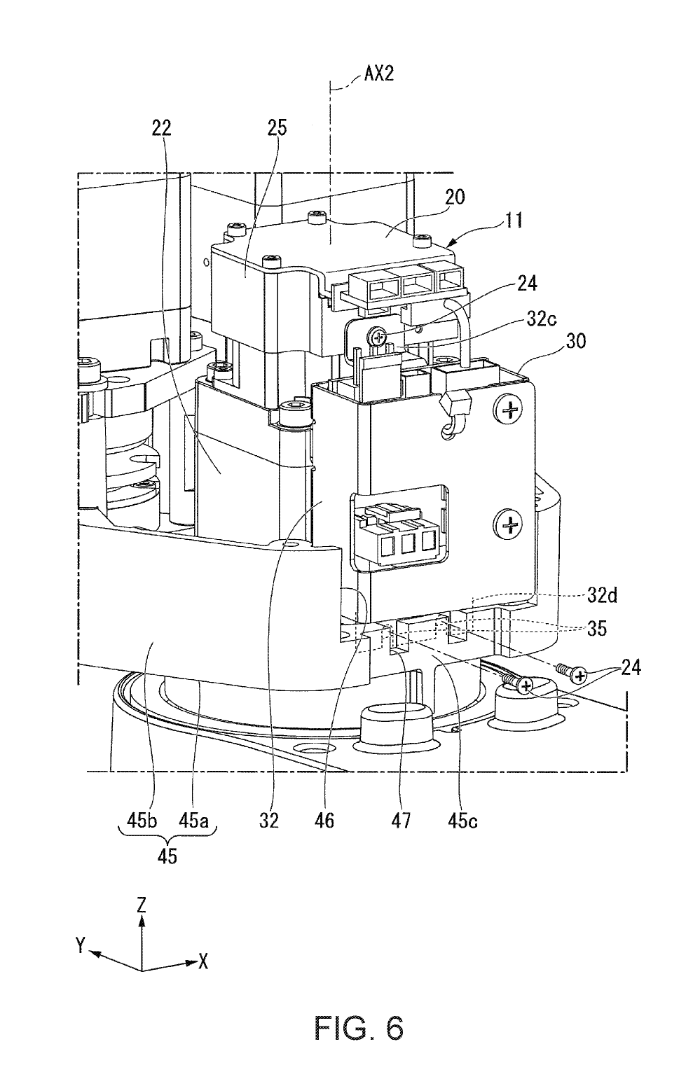

FIG. 6 is a partial perspective view of the arm main body 40 and shows the periphery of the first motor unit 11.

In the sidewall section 45b of the lower cover 45, a low wall section 45c, where the projection height from the bottom plate section 45a locally decreases, is provided. A first opening section 46 opening in the horizontal direction (a direction orthogonal to the second axis AX2) is formed from the inner side toward the outer side of the lower cover 45. That is, the first opening section 46 is provided in the sidewall section 45b of the lower cover 45. In the low wall section 45c, cutout-shaped second opening sections 47 extending from the upper end edge to the lower side are provided. The second opening sections 47 are opened in the direction orthogonal to the second axis AX2.

The amplifier section 30 of the first motor unit 11 is disposed in the first opening section 46. A part of the amplifier section 30 of the first motor unit 11 is located on the outside of the arm main body 40 via the first opening section 46. Note that the first motor unit 11 is covered by the arm cover 41 (see FIG. 2) from the horizontal direction and the upward direction in a state in which the arm cover 41 is attached to the arm main body 40.

The amplifier section 30 of the first motor unit 11 is fixed to the motor 20 via the first and second leg plate sections 32c and 32d of the bracket 32. The first leg plate section 32c is located on the upper end side of the bracket 32. The second leg plate section 32d is located on the lower end side of the bracket 32.

Holes (not shown in the figure) are provided in the first leg plate section 32c of the bracket 32. The screws 24 are inserted into the screw holes 23 (see FIG. 5) on the motor 20 side via the holes. Consequently, the first leg plate section 32c is fixed to the motor 20.

In the second leg plate section 32d, cutout sections 35 extending from the lower end edge toward the upper side are provided. The screws 24 (fixing members) 24 for fixing the amplifier section 30 to the bracket 32 are located on the inner sides of the cutout sections 35. The screws 24 located on the inner sides of the cutout sections 35 are inserted into the screw holes 23 on the motor 20 side, whereby the second leg plate section 32d is fixed to the motor 20. The second leg plate section 32d is opposed to the lower wall section 45c of the lower cover 45. The second opening sections 47 provided in the low wall section 45c are formed along the axes of the screws 24. An operator inserts a driver into the second opening sections 47 to rotate the screws 24.

According to this embodiment, the first opening section 46 is provided in the lower cover 45 of the arm main body 40. A part of the amplifier section 30 is located on the outside of the arm main body 40 in plan view via the first opening section 46. Therefore, since the amplifier section 30 of the first motor unit 11 is located on the inner side of the arm main body 40 in plan view, compared with when the sidewall section 45b is extended to the outer side of the amplifier section 30, it is possible to form the arm main body 40 compact. As a result, it is possible to expand the movable area of the arm main body 40.

Note that, in the illustration in this embodiment, a part of the amplifier section 30 of the first motor unit 11 is located on the outside of the arm main body 40. However, if at least a part of the amplifier section 30 or the motor 20 is located on the outside of the arm main body 40 in plan view, it is possible to achieve the effect of the compactness. In the illustration in this embodiment, the motor unit in which the amplifier section 30 and the motor 20 are connected to each other is configured. However, even when the amplifier section 30 and the motor 20 are separately provided in the arm main body 40 in any one of the plurality of motor units, if at least a part of the amplifier section 30 or the motor 20 is located on the outside of the arm main body 40 in plan view, it is possible to achieve the effect of the compactness. Further the plurality of motors 20 or amplifier sections 30 may be located on the outer side of the arm main body 40.

In this embodiment, the first opening section 46 is formed in the cutout shape from the upper end to the lower end of the sidewall section 45b. However, the first opening section 46 may be a through-hole that pierces through the sidewall section 45b in the thickness direction.

According to this embodiment, since the amplifier section 30 is located on the outside of the arm main body 40 in plan view, it is possible to facilitate access by the operator during maintenance. The amplifier section 30 is fixed in the second leg plate section 32d by the screws 24 that pass through the cutout sections 35 of the second leg plate section 32d. Therefore, the amplifier section 30 is easily detached by loosening the screws 24 and moving the amplifier section 30 to the upper side (in one direction).

Note that, in this embodiment, cutout sections are not provided in the first leg plate section 32c. The screws 24 are inserted through the holes of the first leg plate section 32c. Therefore, when the amplifier section 30 is detached, it is necessary to pull out the screws 24 for fixing the first leg plate section 32c. Cutout sections may be provided instead of the holes in the first leg plate section 32c as well to make it easier to detach the amplifier section 30 from the motor 20.

In the embodiment, the screws 24 are adopted as the fixing members for fixing the amplifier section 30 and the motor 20. As the fixing members, besides the screws 24, for example, a combination of a drive pin extending from the motor 20 and a retaining ring may be used.

According to this embodiment, since the amplifier section 30 of the first motor unit 11 is located on the outside of the arm main body 40, it is possible to improve heat radiation efficiency of the amplifier section 30. On the inside of the arm main body 40, since the plurality of motors 20 and the plurality of amplifier sections 30 are concentratedly disposed, heat easily accumulates. Since the first motor unit 11 drives the rotation shaft body 2, the first motor unit 11 requires large torque, an operating current of the first motor unit 11 easily increases, and the first motor unit 11 easily generates heat. By disposing the amplifier section 30 of the first motor unit 11 on the outer side of the arm main body 40, it is possible to separate the amplifier section 30, heat generation of which is large, from other heat sources (other motors and other amplifier sections) and improve the heat radiation efficiency.

As shown in FIG. 3, according to this embodiment, the gap D is provided between the arm cover 41 and the arm main body 40. Since the arm main body 40 is located on the outer side of the amplifier section 30, the air flowing in from the gap D directly cools the amplifier section 30. Further, according to this embodiment, since the vent hole 41a is provided in the arm cover 41, it is possible to discharge the inflow air from the upper side. It is possible to form circulation of the air for cooling the amplifier section 30. Consequently, it is possible to expect further improvement of the cooling efficiency of the amplifier section 30. Since the vent hole 41a is located immediately above the amplifier section 30, it is possible to efficiently discharge the air heated by the amplifier section 30.

Note that, as the configuration of the vent hole 41a of the arm cover 41, other than the illustration in this embodiment, for example, a plurality of vent holes may be provided on the side surface of the arm cover 41 extending in the circumferential direction of the second axis AX2. In this case, every time the second arm A2 operates, it is possible to take the air into the inside of the second arm A2 via the vent holes.

Further, as indicated by an alternate long and two short dashes line in FIG. 3, in the arm cover 41, a filter 48 that covers the gap D and the vent hole 41a from the outer side may be provided. The filter 48 may be located on the inner side of the second arm A2. The filter 48 prevents dust and the like from moving from the inside to the outside or from the outside to the inside of the second arm A2. Consequently, it is possible to provide the robot 1 usable in a clean room and the like. In addition, a structure may be adopted in which airtightness on the inside of the second arm A2 is improved by covering the gap D and the vent hole 41a with a gasket or the like.

### Modification 1

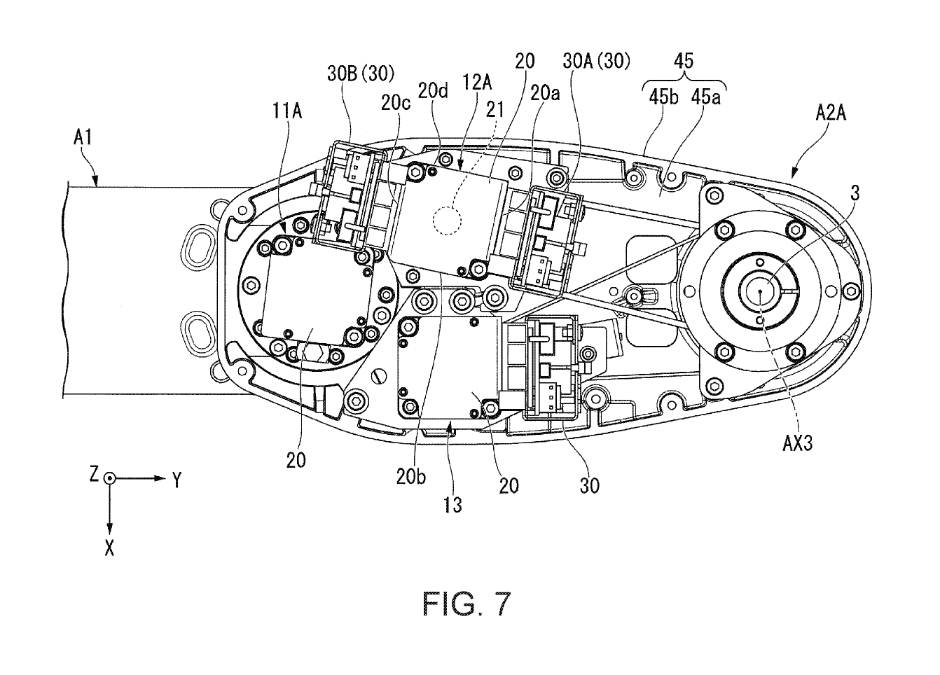

FIG. 7 is a plan view of a second arm A2A in a modification 1.

In the second arm A2A in this modification, compared with the second arm A2 in the embodiment, disposition of the amplifier section 30 is mainly different. Note that the same components as the components in the embodiment are denoted by the same reference numerals and signs and explanation of the components is omitted.

In the second arm A2A, a first motor unit 11A, a second motor unit 12A, and the third motor unit 13 are provided. The first to third motor units 11A, 12A, and 13 respectively include the motors 20 and the amplifier sections 30. The amplifier section 30 of the first motor unit 11A is referred to as second amplifier section 30B. The amplifier section 30 of the second motor unit 12A is referred to as first amplifier section 30A. Both of the first and second amplifier sections 30A and 30B are fixed to the motor 20 of the second motor unit 12A.

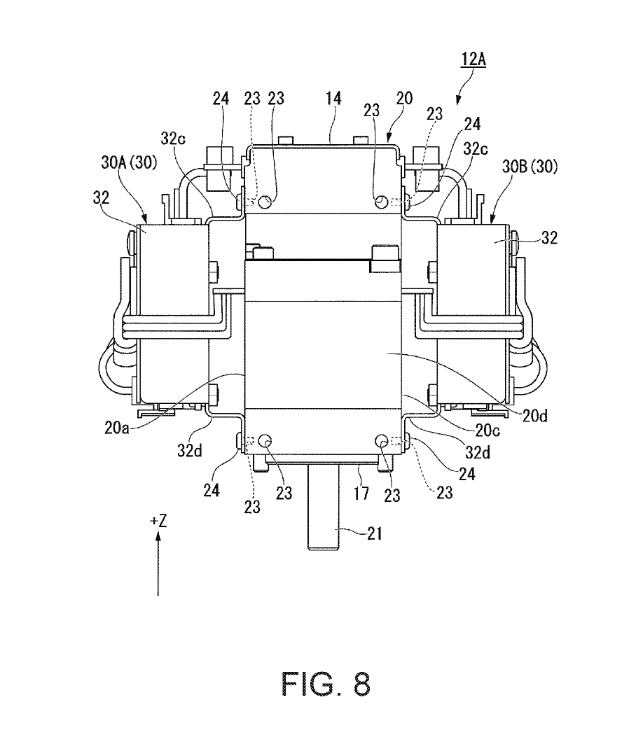

FIG. 8 is a side view of the second motor unit 12A.

In the motor 20 of the second motor unit 12A, the first amplifier section 30A is attached to the first surface 20a. The second amplifier section 30B is attached to the third surface 20c. That is, in the second motor unit 12A, the first amplifier section 30A is detachably attached to the screw holes (the first sections) 23 provided in the first surface 20a of the motor 20. The second amplifier section 30B is detachably attached to the screw holes (the second sections) 23 provided in the third surface 20c.

According to this modification, since the motor 20 includes a plurality of attaching positions (the first to fourth surfaces 20a, 20b, 20c, and 20d), it is possible to attach a plurality of amplifier sections 30 to one motor 20. Consequently, in the second arm A2A, it is possible to improve flexibility of member disposition. As a result, it is possible to achieve compactness of the second arm A2A.

According to this modification, the shaft (a rotation shaft) 21 of the motor (the first motor) 20 of the second motor unit 12A is provided between the first surface 20a, to which the first amplifier section 30A is attached, and the third surface 20c, to which the second amplifier section 30B is attached. That is, the first and second amplifier sections 30A and 30B are disposed in opposite directions each other with respect to the motor 20 of the second motor unit 12A. Consequently, the first and second amplifier sections 30A and 30B and the motor 20 are arrayed in one direction in plan view. When the second arm A2A is increased in size in the width direction (the latitudinal direction), a movable range of the second arm A2A decreases. On the other hand, in the second arm A2A, a housing space is easily secured in the longitudinal direction. By arranging an array direction of the first and second amplifier sections 30A and 30B and the motor 20 to be along the longitudinal direction of the second arm A2A, it is possible to reduce the width dimension of the second arm A2A.

The brackets 32 of the first and second amplifier sections 30A and 30B have high heat radiation efficiency and function as heat sinks. According to this modification, a plurality of amplifier sections (the first and second amplifier sections 30A and 30B) are provided in the motor 20 having a high operation frequency and large operation torque to radiate heat. Therefore, it is possible to improve operation efficiency of the motor 20.

### Modification 2

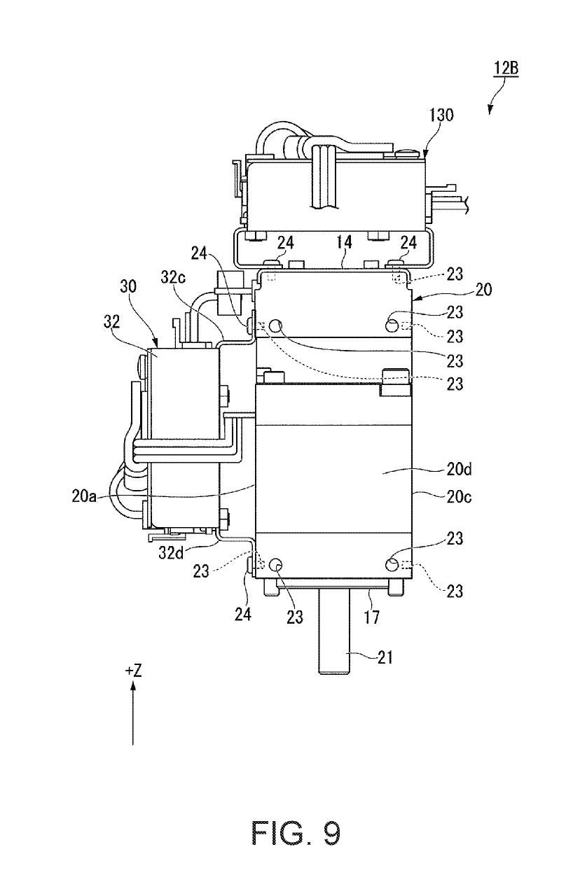

FIG. 9 is a side view of a motor unit 12B in a modification 2.

In the motor unit 12B in this modification, as in the motor unit 12A in the modification 1, one motor 20 supports two amplifier sections 30 and 130.

The screw holes (the attaching/detaching sections) 23 for fixing the motor 20 are respectively provided in the top surface 14 and the first to fourth surfaces 20a, 20b, 20c, and 20d of the motor 20 of the motor unit 12B. In this modification, in the motor 20, one amplifier section 30 is fixed to the screw holes 23 of the first surface 20a and the other amplifier section 130 is fixed to the screw holes 23 of the top surface 14.

According to this modification, since the amplifier section 130 is fixed to the top surface 14 of the motor 20, it is possible to effectively use a space above the motor 20 in the second arm A2. As a result, it is possible to form the second arm A2 compact.

### Modification 3

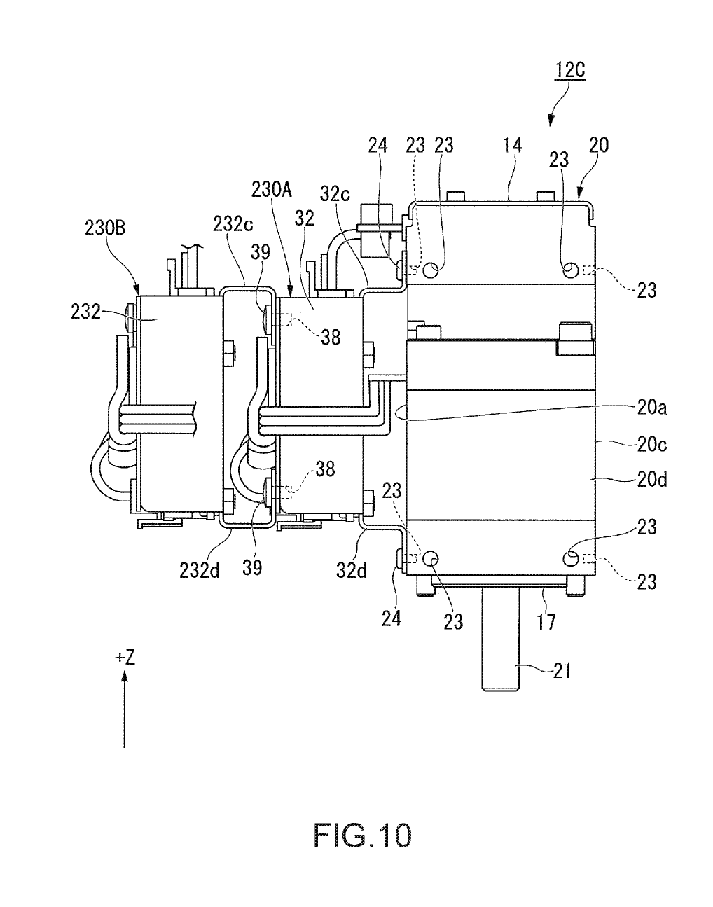

FIG. 10 is a side view of a motor unit 12C in a modification 3.

In the motor unit 12C in this modification, as in the motor unit 12A in the modification 1, one motor 20 supports two amplifier sections (a first amplifier section 230A and a second amplifier section 230B).

The first amplifier section 230A drives the motor (the first motor) 20 of the motor unit 12C. The second amplifier section 230B drives the motor (the second motor) 20 different from the motor 20 of the motor unit 12C. Note that a relation between the first and second amplifier sections 230A and 230B and the motors 20 driven by the first and second amplifier sections 230A and 230B may be opposite to the relation explained above. Both of the first and second amplifier sections 230A and 230B may drive different motors 20.

The first amplifier section 230A is fixed to the screw holes 23 provided in the first surface 20a of the motor 20 of the motor unit 12C. That is, the motor (the first motor) 20 includes the screw holes (the first sections) 23 that enable the first amplifier section 230A to be attached and detached.

In the first amplifier section 230A, screw holes (the third sections) 38 that enable the second amplifier section 230B to be attached and detached are provided. The second amplifier section 230B is fixed to the screw holes 38 of the first amplifier section 230A by screws 39. That is, the second amplifier section 230B is supported by the motor 20 via the first amplifier section 230A.

According to this modification, since the motor 20 supports a plurality of amplifier sections (the first and second amplifier sections 230A and 230B) to be superimposed one on top of the other, it is possible to improve flexibility of member disposition in the second arm A2. Consequently, it is possible to achieve compactness of the second arm A2.

According to this modification, the first and second amplifier sections 230A and 230B and the motor 20 are arrayed in one direction in plan view. By arranging an array direction of the first and second amplifier sections 230A and 230B and the motor 20 to be along the longitudinal direction of the second arm A2, it is possible to reduce the width dimension of the second arm A2.

In this modification, the second amplifier section 230B is fixed to the motor 20 via the first amplifier section (an interposed member) 230A. The first amplifier section 230A is fixed to the screw holes (the attaching/detaching sections) 23 provided in the first surface 20a of the motor 20. Therefore, the first amplifier section 230A functioning as the interposed member is provided between the screw holes 23 and the second amplifier section 230B. In this way, the amplifier section may be fixed to the motor 20 via the interposed member. In an illustration in this modification, the first amplifier section 230A functions as the interposed member. However, the interposed member may be a separately prepared member.

### Second Embodiment

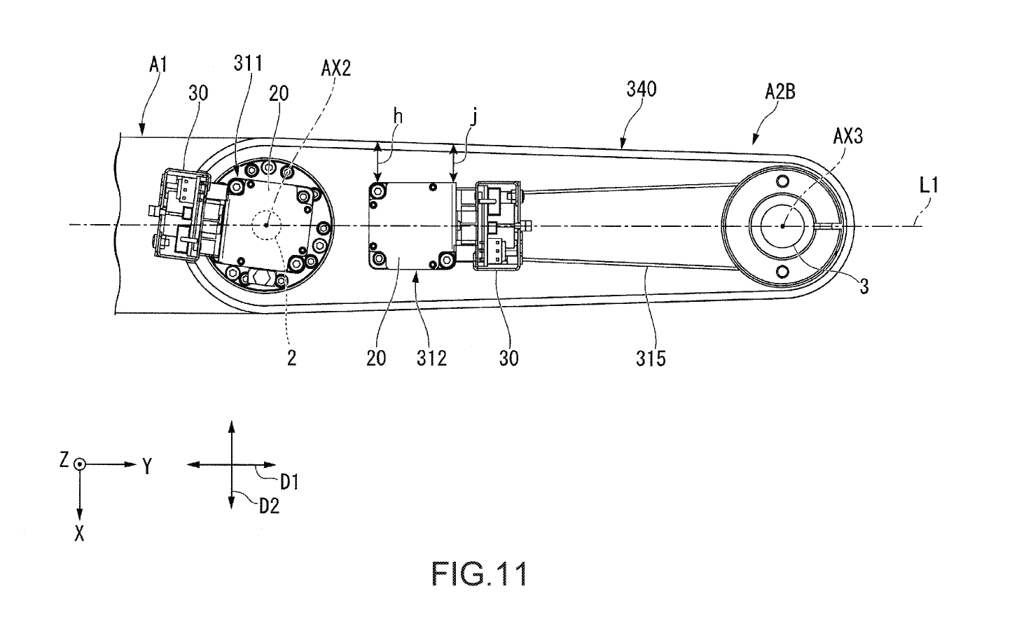

FIG. 11 is a plan view of a second arm A2B in a second embodiment.

In the second arm A2B in this embodiment, compared with the second arm A2 in the first embodiment, the number of motor units provided in an arm main body 340 is different. Note that the same components as the components in the first embodiment are denoted by the same reference numerals and signs and explanation of the components is omitted.

The second arm A2B includes the arm main body 340, a first motor unit 311, a second motor unit 312, a rotation shaft body 2 extending along the second axis (the rotation axis) AX2, and the actuating shaft body 3 extending along the third axis (the actuation axis) AX3. The arm main body 340 holds the first and second motor units 311 and 312, the actuating shaft body 3, and the rotation shaft body 2.

The first and second motor units 311 and 312 respectively include the motors 20 and the amplifier sections 30. The first motor unit 311 drives to rotate the rotation shaft body 2 with respect to the arm main body 340. The second motor unit 312 rotates a ball screw nut via a timing belt 315 to lift and lower the actuating shaft body 3.

In plan view, a shortest distance j along the second direction D2 between the motor 20 of the second motor unit 312 and the outer edge of the arm main body 340 is smaller than the thickness of the amplifier section 30 (i.e., the length of the amplifier section 30 in the normal direction of the amplifier board 31 (see FIG. 5)). Consequently, it is possible to reduce the distance between the motor 20 and the arm main body 340 and reduce the dimension along the second direction D2 of the arm main body 340.

In plan view, a longest distance h along the second direction D2 between the motor 20 of the second motor unit 312 and the outer edge of the arm main body 340 is smaller than the thickness of the amplifier section 30. Therefore, a gap in which the amplifier section 30 is provided is absent between the outer edge of the arm main body 340 and the motor 20 of the second motor unit 312. As a result, it is possible to reduce the dimension along the second direction D2 of the second arm A2B.

### Third Embodiment

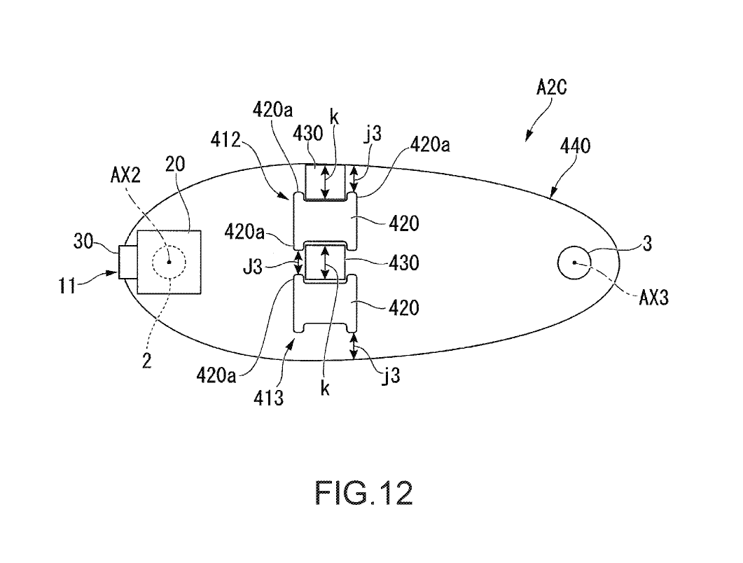

FIG. 12 is a plan schematic view of a second arm A2C in a third embodiment.

In the second arm A2C in this embodiment, compared with the second arm A2 in the first embodiment, the configuration of a motor 420 provided in an arm main body 440 is different. Note that the same components as the components in the embodiments explained above are denoted by the same reference numerals and signs and explanation of the components is omitted.

The second arm A2C includes the arm main body 440, the first motor unit 11, a second motor unit 412, a third motor unit 413, the rotation shaft body 2 extending along the second axis (the rotation axis) AX2, and the actuating shaft body 3 extending along the third axis (the actuation axis) AX3.

The first motor unit 11 has the same configuration as the configuration in the first embodiment. The second and third motor units 412 and 413 respectively include motors 420 and amplifier sections 430. The second motor unit 412 rotates a ball screw nut via a timing belt (not shown in the figure) to lift and lower the actuating shaft body 3. The third motor unit 413 rotates the actuating shaft body 3 around the third axis AX3 via a timing belt (not shown in the figure). The second motor unit 412 and the third motor unit 413 are disposed side by side in the second direction D2.

The motors 420 of the second and third motor units 412 and 413 have a rectangular shape in plan view. Convex portions 420a are provided at four corner portions of the motor 420. The convex portions 420a project along the second direction D2.

The amplifier section 430 of the second motor unit 412 is disposed in the second direction D2 with respect to the motor 420 of the second motor unit 412. The amplifier 430 is located between the convex portions 420a of the motor 420.

The amplifier section 430 of the third motor unit 413 is disposed in the second direction D2 with respect to the motor 420 of the third motor unit 413 and between the motor 420 and the motor 420 of the second motor unit 412. The amplifier section 430 is located between the convex portions 420a of the motor 420.

In plan view, a shortest distance j3 along the second direction D2 between the motor 420 of the second motor unit 412 and the outer edge of the arm main body 440 is smaller than thickness k of the amplifier section 430. Similarly, the shortest distance j3 along the second direction D2 between the motor 420 of the third motor unit 413 and the outer edge of the arm main body 440 is smaller than the thickness k of the amplifier section 430. A gap forming the shortest distance j3 is located between the convex portions 420a of the motor 420 and the outer edge of the arm main body 440. Consequently, it is possible to reduce the distance between the motor 420 and the outer edge of the arm main body 440 and reduce the dimension along the second direction D2 of the arm main body 440.

In plan view, a shortest distance J3 along the second direction D2 between the motors 420 of the second and third motor units 412 and 413 is smaller than the thickness k of the amplifier section 430. A gap forming the shortest distance J3 is located between the convex portions 420a of the motors 420 of the second and third motor units 412 and 413. Consequently, it is possible to reduce the distance between the motors 420 of the second and third motor units 412 and 413 and reduce the dimension along the second direction D2 of the arm main body 440.

A concave portion is formed between the convex portions 420a of the motor 420. The concave portion is formed by, for example, recessing an unnecessary space of the motor 420. That is, according to this embodiment, by forming the unnecessary space of the motor 420 as the concave portion and disposing the amplifier section 430 in the concave portion, even when the amplifier section 430 is disposed in the second direction D2, it is possible to reduce the dimension in the latitudinal direction of the second arm A2C.

As explained in this embodiment, even when the amplifier section 430 is disposed in the second direction with respect to the motor 420, by setting the shortest distances J3 and j3 smaller than the thickness k of the amplifier section 430, it is possible to achieve a certain effect for a reduction in the size of the arm main body 440.

The various embodiments of the invention are explained above. However, the components, the combinations of the components, and the like in the embodiments are examples. Addition, omission, replacement, and other changes of components are possible without departing from the spirit of the invention. The invention is not limited by the embodiments.

Note that, in the illustrations in the embodiments, the robot is the horizontal multi-joint robot. However, the robot may be other robots such as a vertical multi-joint robot and a Cartesian coordinate robot instead of the SCARA robot. Note that the vertical multi-joint robot may be a single-arm robot including one manipulator, may be a double-arm robot including two manipulators (a plural-arm robot including two manipulators), or may be a plural-arm robot including three or more manipulators. The Cartesian coordinate robot is, for example, a gantry robot.

In the embodiments, the motor units provided in the second arm are mainly explained. The same configuration as the configuration of the motor units provided in the second arm can also be adopted in motor units on the inside of a base stand.

In the embodiments, the motor and the amplifier section integrally configured as the motor unit are mainly explained. However, in the embodiments, a configuration may be adopted in which any one of the plurality of amplifier sections is not fixed to the motor and is directly attached to the arm main body. In the embodiments, any one of the plurality of amplifier sections may be fixed to each of the motor and the arm main body.

The entire disclosures of Japanese Patent Application Nos. 2016-168985, filed Aug. 31, 2016 and 2017-107558, filed May 31, 2017 are expressly incorporated by reference herein.

What is claimed is:

1. A motor unit comprising:
a first motor; and
a first amplifier section including a driving circuit for driving the first motor, wherein
the first motor includes:
a first section configured to enable the first amplifier section to be attached to and detached from a first position; and
a second section configured to enable the first amplifier section to be attached to and detached from a second position different from the first position.

2. The motor unit according to claim 1, wherein the first position and the second position are located on different surfaces on a surface of the first motor.

3. The motor unit according to claim 1, wherein a rotating shaft of the first motor is provided between the first position and the second position.

4. The motor unit according to claim 1, wherein the second section is capable of attaching and detaching a second amplifier section including a driving circuit for driving a second motor different from the first motor.

5. A motor unit comprising:
a first motor; and
a first amplifier section including a driving circuit for driving the first motor, wherein
the first motor includes a first section configured to enable the first amplifier section to be attached and detached,
the first amplifier section includes a third section configured to enable a second amplifier section, which includes a driving circuit for driving a second motor different from the first motor, to be attached and detached.

6. The motor unit according to claim 1, wherein interposed members are interposed between the sections and the amplifier sections.

7. A robot comprising:
the motor unit according to claim 4;
an arm capable of rotating around a rotation axis; and
an actuating shaft body provided in the arm and configured to rotate around an actuation axis, wherein
either one of the first motor and the second motor drives the arm around the rotation axis, and
the other drives the actuating shaft body.

8. A robot comprising:
the motor unit according to claim 5;
an arm capable of rotating around a rotation axis; and
an actuating shaft body provided in the arm and configured to rotate around an actuation axis, wherein
either one of the first motor and the second motor drives the arm around the rotation axis, and
the other drives the actuating shaft body.
